(19) United States
(12) Patent Application Publication
(10) Pub. No.: US 2024/0272387 A1
(43) Pub. Date: Aug. 15, 2024

(54) OPTICAL MODULE AND ASSEMBLY METHOD THEREFOR

(71) Applicant: INNOLIGHT TECHNOLOGY (SUZHOU) LTD., Suzhou (CN)

(72) Inventors: Fengli YANG, Suzhou (CN); Changwu LU, Suzhou (CN)

(21) Appl. No.: 18/644,583

(22) Filed: Apr. 24, 2024

Related U.S. Application Data
(63) Continuation of application No. PCT/CN2021/135601, filed on Dec. 6, 2021.

(30) Foreign Application Priority Data
Oct. 29, 2021 (CN) 202111277544.9

(51) Int. Cl. G02B 6/42

(52) U.S. Cl. CPC G02B 6/4261

(57) ABSTRACT

An optical module includes a housing, a pull ring assembly, an optical assembly, and a circuit board assembly. An optical interface and an electrical interface are formed at two opposite ends of the housing. The housing includes a bottom wall and two side walls. Two suspension arm accommodating grooves are formed on the two side walls. The pull ring assembly includes two suspension arms and a suspension arm connecting portion. Each suspension arm is disposed in a corresponding one of the suspension arm accommodating grooves. The suspension arm connecting portion is disposed on an external surface of the bottom wall of the housing. When the pull ring assembly moves, the suspension arms are subject to limitation by upper groove walls and lower groove walls of the suspension arm accommodating grooves and move left-right along a direction of a line connecting the optical interface and the electrical interface.

### CROSS-REFERENCE TO RELATED APPLICATION

This application is a continuation of International Patent Application No. PCT/CN2021/135601, filed on Dec. 6, 2021, which claims priority to Chinese Patent application Ser. No. 202111277544.9, filed on Oct. 29, 2021. All of the foregoing applications are incorporated herein by reference in their entireties.

### TECHNICAL FIELD

The present disclosure relates to the field of optical communication technology and more particularly to an optical module and its assembly method.

### BACKGROUND

As computer technology, communication technology, and Internet of Things technology continue to develop, optical modules, whose fundamental function is electrical-to-optical and optical-to-electrical conversion, are gradually evolving towards higher speed, lower power consumption, miniaturization, hot swapping, and increased intelligence. As modular units of optical communication systems, optical modules work in cooperation with optical communication network equipment to achieve optical transmission.

As of now, in the production and manufacturing process, optical modules need to undergo a series of debugging and testing before final assembly and shipment. In addition, after the completion of the final assembly, the optical modules might need to have their unlocking pull rings replaced due to objective factors. Many optical module structural designs that exist now have the pull ring disposed between an upper lid and a base; when the unlocking pull ring is being replaced, the upper lid needs to be opened. However, once the upper lid is opened, debugging and testing that have been performed previously need to be performed again, thus greatly reducing production efficiency.

### SUMMARY

Therefore, it is necessary to provide an optical module and its assembly method to address the above problem of inconvenient replacement of the unlocking pull ring of the optical module, as well as the problem of low production efficiency caused by the need for re-performance of debugging and testing after the replacement.

Consistent with disclosed embodiments, there is provided an optical module including a housing, a pull ring assembly disposed on the housing, and an optical assembly and a circuit board assembly disposed in the housing, an optical interface and an electrical interface being formed at two opposite ends of the housing.

The housing includes a bottom wall and two oppositely disposed side walls formed on the bottom wall. Two suspension arm accommodating grooves are formed on the two side walls, respectively. Each suspension arm accommodating groove includes a groove bottom, an upper groove wall, and a lower groove wall. A travel limiting groove is formed on the lower groove wall of each suspension arm accommodating groove.

The pull ring assembly includes two oppositely disposed suspension arms and a suspension arm connecting portion connecting the two suspension arms together; a handle used for unlocking in cooperation with an external mechanism, and a protrusion are disposed at an end portion of the suspension arm. For each suspension arm, the protrusion is obliquely disposed from the suspension arm connecting portion with respect to the suspension arm.

Each suspension arm is disposed in a corresponding one of the suspension arm accommodating grooves. The protrusion of each suspension arm is disposed in the travel limiting groove of the corresponding suspension arm accommodating groove. The suspension arm connecting portion is disposed on an external surface of the bottom wall of the housing;

When the pull ring assembly moves with respect to the housing, the suspension arms are subject to limitation by the upper groove wall and the lower groove wall and moves left-right along a direction of a line connecting the optical interface and the electrical interface, and the travel limiting grooves and the protrusions cooperate to limit a left-right moving distance of the pull ring assembly. The upper groove wall, the lower groove wall, and the travel limiting grooves together limit the suspension arms from separating from the suspension arm accommodating grooves when the suspension arms move with the pull ring assembly.

In the above optical module, the optical assembly and the circuit board assembly are disposed in the housing to form a single assembly for a series of debugging and testing. After the debugging and testing are completed, the suspension arms are disposed in the suspension arm accommodating grooves, respectively, and the protrusions are directly fit into the travel limiting grooves, respectively, thereby completing the entire assembly process. At this time, when the pull ring assembly is pulled to move with respect to the housing, the suspension arms are subject to limitation by the upper groove walls and the lower groove walls and move left-right along a direction of a line connecting the optical interface and the electrical interface, and the travel limiting groove and the protrusion cooperate to limit the distance of the pull ring assembly moving left-right; and the upper groove wall, the lower groove wall, and the travel limiting groove together limit the suspension arm, when it moves with the pull ring assembly, from separating from the suspension arm accommodating groove, so as to enable the pull ring assembly to move left-right a set distance with respect to the housing along the direction of a line connecting the optical interface and the electrical interface. When the pull ring assembly needs to be replaced, what needs to be done is simply to pry the suspension arms away from the suspension arm accommodating grooves and cause the protrusions to be separated from the travel limiting grooves, so that the suspension arms can be removed from the housing, and then a new pull ring assembly may be formed. In the process of replacement, the assembly formed by the optical assembly, the circuit board assembly, and the housing does not need to be disassembled. Therefore, the replacement of the pull ring assembly does not require re-performance of the series of debugging and testing, and the replacement of the pull ring assembly is simpler and easier and has higher production efficiency.

In one embodiment, the optical module only includes two of the suspension arms and two of the protrusions. The two suspension arms and the two protrusions are disposed in a one-to-one corresponding manner.

In one embodiment, the optical module includes an elastic component. The suspension arm connecting portion is closely fit to an outer surface of the bottom wall of the housing. The suspension arm connecting portion has disposed thereon a window for the elastic component to pass through, and a stop block correspond to the window. An elastic component accommodating groove used for accommodating the elastic component is disposed on the bottom wall of the housing at a location corresponding to the window and the stop block. The elastic component is disposed in the elastic component accommodating groove.

In one embodiment, the optical module includes an elastic component. One of the suspension arms has disposed thereon a window for the elastic component to pass through, and a stop block correspond to the window. An elastic component accommodating groove used for accommodating the elastic component is disposed on the groove bottom of the corresponding suspension arm accommodating groove at a location corresponding to the window and the stop block. The elastic component is disposed in the elastic component accommodating groove.

In one embodiment, an opening running through from the bottom wall of the housing to the elastic component accommodating groove is disposed on the corresponding side wall of the housing. The opening is obliquely disposed from the corresponding travel limiting groove with respect to the corresponding suspension arm accommodating groove. The stop block on the suspension arm is disposed through the opening into the elastic component accommodating groove.

In one embodiment, a notch running through from the bottom wall of the housing to one of the suspension arm accommodating grooves is disposed on the corresponding side wall. The notch is disposed at a location near the handle. The notch and the travel limiting groove are disposed on two sides of the suspension arm accommodating groove.

In one embodiment, the housing of the optical module includes a first housing and a second housing fixed together to one another. Each suspension arm accommodating groove is disposed at a junction location of the first housing and the second housing and is on both the first housing and the second housing at the same time.

In one embodiment, the protrusion and the travel limiting groove are disposed near the handle.

Additionally, embodiments of the present disclosure provide an optical module, including a first housing, a second housing, a pull ring assembly, an optical assembly, and a circuit board assembly. The first housing and the second housing are assembled and fixed together to one another. The pull ring assembly is disposed outside the first housing and the second housing. The optical assembly and the circuit board assembly are disposed in the first housing and the second housing. An optical interface and an electrical interface are formed at two opposite ends of the first housing and the second housing.

The first housing and the second housing each includes a bottom wall and two oppositely disposed side walls formed on the bottom wall. Two suspension arm accommodating grooves are formed on the two side walls of at least one of the first housing and the second housing. Each suspension arm accommodating groove includes a groove bottom, an upper groove wall, and a lower groove wall. A travel limiting groove is formed on the lower groove wall of each suspension arm accommodating groove.

The pull ring assembly includes two oppositely disposed suspension arms. A handle used for unlocking in cooperation with an external mechanism, and a protrusion are disposed at an end portion of each suspension arm.

Each suspension arm is disposed in a corresponding one of the suspension arm accommodating grooves. The protrusion of each suspension arm is disposed in the travel limiting groove of the corresponding suspension arm accommodating groove. A suspension arm connecting portion is disposed on an external surface of the bottom wall of one of the first housing and the second housing.

After the first housing and the second housing are fixed together, the suspension arms are assembled into the respectively corresponding suspension arm accommodating grooves.

Additionally, the embodiments of the present disclosure further provide an assembly method for the optical module of any of the above technical solutions, including:
providing the housing, the optical assembly, the circuit board assembly, and the pull ring assembly, and assembling the optical assembly and the circuit board assembly in the housing;
packaging the housing; and
assembling the pull ring assembly outside the housing.

In the above assembly method for the optical module, first, the housing, the optical assembly, the circuit board assembly, and the pull ring assembly are provided, and the optical assembly and the circuit board assembly are disposed in the housing. The optical assembly, the circuit board assembly, and the housing form a single assembly. Next, the housing is packaged, so as to complete the assembly of the optical assembly, the circuit board assembly, and the housing, and subsequent operations are performed after a series of debugging and testing after the assembly. Finally, the pull ring assembly is assembled outside the housing. At this time, the suspension arms are disposed in the suspension arm accommodating grooves, respectively, and the protrusions are fit in the travel limiting grooves, respectively, thereby completing the assembly of the optical module. In the assembly method for the optical module, the assembly process is simpler and more convenient.

In one embodiment, the step of assembling the pull ring assembly outside the housing includes:
assembling the pull ring assembly into the suspension arm accommodating grooves; and
assembling an elastic component into an elastic component accommodating groove through a window.

In one embodiment, the step of assembling the pull ring assembly into the suspension arm accommodating grooves includes assembling the pull ring assembly into the suspension arm accommodating grooves by moving the pull ring assembly from one side distant from a travel limiting groove towards the travel limiting groove.

With the assembly method for the optical module provided by the embodiments of the present disclosure, there is no need to repeat a series of debugging and testing when the pull ring assembly is replaced, and the replacement of the pull ring assembly is simpler and easier and has higher production efficiency.

### BRIEF DESCRIPTION OF DRAWINGS

FIG. 1 is a structural diagram illustrating an optical module according to an embodiment of the present disclosure;

FIG. 2 is an exploded schematic view of the optical module in FIG. 1;

FIG. 3 is a structural diagram of the optical module in FIG. 1 with its pull ring assembly removed;

FIG. 4 is a structural diagram illustrating a first housing of the optical module in FIG. 1;

FIG. 5 is an enlarged schematic view of the optical module in FIG. 1 at location A;

FIG. 6 is an enlarged schematic view of the optical module in FIG. 1 at location B;

FIG. 7 is a flowchart illustrating an assembly method for an optical module according to an embodiment of the present disclosure.

### REFERENCE NUMERALS IN THE DRAWINGS

10: optical module;
100: housing; 110: first housing; 111: first bottom wall; 112: first side wall; 120: second housing; 121: second bottom wall; 122: second side wall; 123: elastic component accommodating groove; 130: suspension arm accommodating groove; 131: groove bottom; 131a: first plane; 131b: first slope; 131c: second plane; 131d: third plane; 132: upper groove wall; 132a: notch; 133: lower groove wall; 133b: travel limiting groove; 101: fastener; 102: optical interface; 103: electrical interface;
200: pull ring assembly; 210: suspension arm; 211: first straight-line section; 212: first connecting section; 213: second straight-line section; 213b: protrusion; 214: handle; 220: ring; 230: suspension arm connecting portion; 231: window; 232: stop block; 240: elastic component;
300: optical assembly;
400: circuit board assembly; 410: circuit board.

### DETAILED DESCRIPTION

In order to make the above purpose, features, and advantages of the present disclosure more obvious and understandable, a detailed description of specific modes for carrying out the present disclosure is provided below in conjunction with the drawings. Many specific details are elaborated in the following description to facilitate a full understanding of the present disclosure. However, the present disclosure can be implemented in many other ways different from those described herein, and persons of skill in the art can make similar improvements without departing from the scope of the present disclosure; therefore, the present disclosure is not limited by the specific embodiments disclosed below.

In the description of the present disclosure, it needs to be understood that orientations or locational relationships indicated by terms such as “center,” “longitudinal,” “transverse,” “length,” “width,” “thickness,” “above,” “below,” “front,” “back,” “left,” “right,” “vertical,” “horizontal,” “top,” “bottom,” “inner,” “outer,” “clockwise,” “counterclockwise,” “axial,” “radial,” and “circumferential,” are based on orientations or positional relationships shown in the drawings. They are intended only to facilitate description of the present disclosure and to simplify the description, and do not indicate or imply that the device or component referred to must have a particular orientation or be constructed and operated in a particular orientation. Therefore, they cannot be construed as limiting the present disclosure.

Moreover, the terms “first” and “second” are used for descriptive purposes only and cannot be construed as indicating or implying relative importance or implicitly specifying the quantity of the technical feature referred to. Therefore, a feature defined as “first” or “second” may include at least one such feature, either explicitly or implicitly. In the description of the present disclosure, the term “plurality” means at least two, such as two or three, unless otherwise defined expressly and specifically.

In the present disclosure, unless otherwise expressly specified and defined, terms such as “install,” “connected,” “connect,” and “fix,” are to be construed in a broad sense; for example, it may indicate a fixed connection, a detachable connection, or an integral connection; it may indicate a mechanical connection or an electrical connection; it may indicate a direct connection, an indirect connection through an intermediate medium, or an internal connect between two components or an interactive relationship between two components; unless otherwise expressly defined. To persons of ordinary skill in the art, the specific meaning of the above terms in the present disclosure may be construed in their specific context.

In the present disclosure, unless otherwise expressly specified and defined, a first feature “above” or “below” a second feature may mean that the first feature and the second feature directly contact one another, or the first feature and the second feature indirectly contact one another through an intermediate medium. And, the first feature “above,” “on top of,” and “over” the second feature may mean that the first feature is directly above or obliquely above the second feature, or simply that the first feature is horizontally higher than the second feature. The first feature “below,” “under,” and “beneath” the second feature may mean that the first feature is directly below or obliquely below the second feature, or simply that the first feature is horizontally lower than the second feature.

It needs to be noted that when a component is referred to as “fixed on” or “disposed on” another component, it may be directly on the other component or there may be a component in between. When a component is considered to be “connected” to another component, it may be directly connected to the other component, or there may be a component in between at the same time. As used herein, the terms “vertical,” “horizontal,” “above,” “below,” “left,” “right,” and similar expressions are for illustrative purposes only and do not indicate that other embodiments are excluded.

The technical solution provided by embodiments of the present disclosure is described below in conjunction with the drawings.

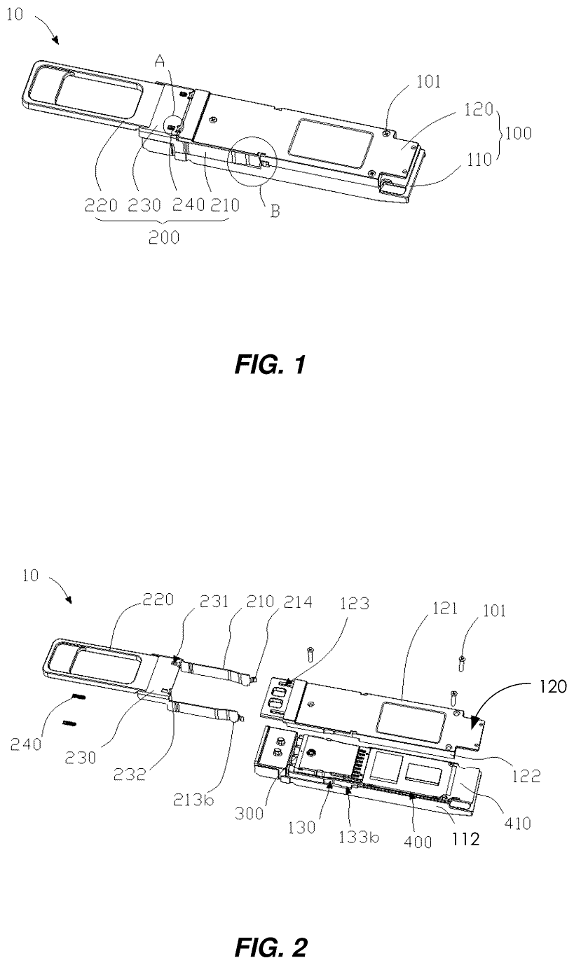

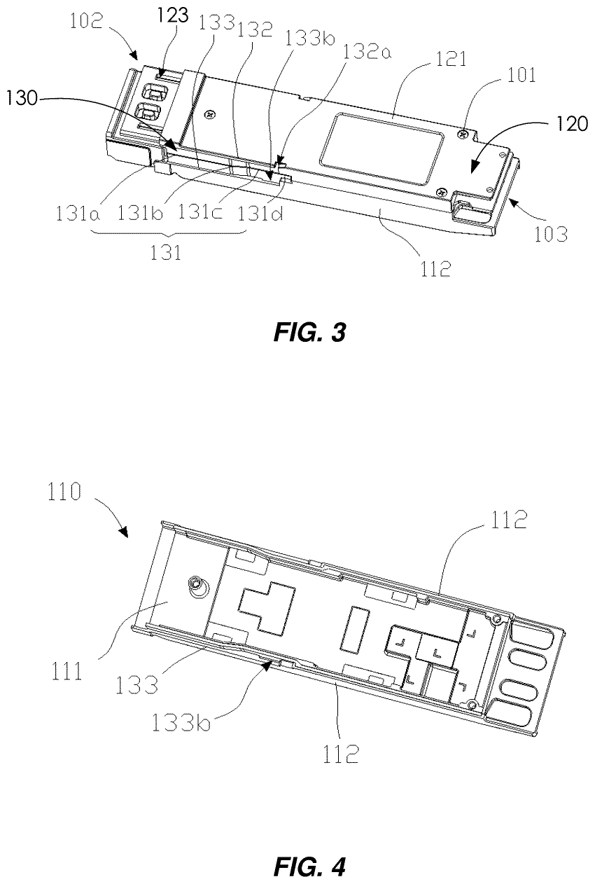

FIG. 1 is a structural diagram illustrating an optical module according to an embodiment of the present disclosure. FIG. 2 is an exploded schematic view of the optical module in FIG. 1. FIG. 3 is a structural diagram of the optical module in FIG. 1 with its pull ring assembly removed. FIG. 4 is a structural diagram illustrating a first housing of the optical module in FIG. 1. As shown in FIGS. 1, 2, 3, and 4, one embodiment of the present disclosure provides an optical module 10. The optical module 10 cooperates with optical communication network equipment to realize optical transmission. The optical module 10 may be plugged into the optical communication network equipment, and the optical module 10 may also be unplugged from the optical communication network equipment. The optical module 10 includes a housing 100, a pull ring assembly 200, an optical assembly 300, and a circuit board assembly 400.

The pull ring assembly 200 includes two suspension arms 210, a pull ring 220, a suspension arm connecting portion 230, and at least one elastic component 240. The suspension arms 210 and the pull ring 220 are connected together by the suspension arm connecting portion 230. Here, the suspension arm connecting portion 230 is a U-shaped structure, its one end being connected to the two suspension arms 210 that are oppositely disposed, its other end being connected to the pull ring 220. Specifically, the suspension arms 210, the pull ring 220, and the suspension arm connecting portion 230 are formed as a single piece, for example, manufactured with an injection molding or casting process. The suspension arms 210, the pull ring 220, and the suspension arm connecting portion 230 may alternatively be a multi-piece structure and are assembled together subsequently by a process such as adhesion or welding.

The optical assembly 300 includes an optical transmitter and an optical receiver, each of which may include one or more passive optical devices and one or more active optical devices. The passive optical devices usually include a wavelength division multiplexer, a lens, a prism, or the like; and the active optical devices usually include a detector, a laser, or the like. The circuit board assembly 400 includes a circuit board 410, as well as an electronic component, an electronic chip, or the like disposed on the circuit board 410. In other embodiments, the optical assembly 300 may, alternatively, have an optical transmitter only or an optical receiver only, and the passive optical devices and the active optical devices may, alternatively, include other components.

The housing 100 includes a first housing 110 and a second housing 120 that are assembled to one another and fixed together. The first housing 110 and the second housing 120 are connected into one piece by one or more fasteners 101, such as a screw. The connection between the first housing 110 and the second housing 120 is not limited to the aforementioned fastener 101 and may alternatively employ another means that is capable of achieving fixed connection. For example, the first housing 110 and the second housing 120 may be detachable connected by a snap-fit connection or a protrusion-depression fit, or may be connected by a welded connection or an adhesion connection. An optical interface 102 and an electrical interface 103 are oppositely disposed at two ends of the housing 100. The first housing 110 and the second housing 120 form an accommodating cavity for the optical assembly 300 and the circuit board assembly 400. At the time of assembly, the optical assembly 300 and the circuit board assembly 400 are disposed in the first housing 110 or the second housing 120; then the first housing 110 and the second housing 120 are fixedly connected; finally, the pull ring assembly 200 is disposed outside the first housing 110 and the second housing 120, thereby achieving the assembly of the optical module 10.

As shown in FIGS. 2 and 3, the first housing 110 includes a first bottom wall 111 and two first side walls 112. The first bottom wall 111 is used for carrying the circuit board assembly 400 and the optical assembly 300. The two first side walls 112 are located on two opposite sides of the first bottom wall 111, and the first side walls 112 both protrude from the first bottom wall 111 in their disposition.

As shown in FIGS. 2 and 3, the second housing 120 includes a second bottom wall 121 and two second side walls 122. The second bottom wall 121 is used for covering the circuit board assembly 400 and the optical assembly 300. The two second side walls 122 are located on two opposite sides of the second bottom wall 121, and the second side walls 122 both protrude from the second bottom wall 121 in their disposition.

Two suspension arm accommodating grooves 130 are formed at a junction of the first housing 110 and the second housing 120, and are used for accommodating the suspension arms 210 of the pull ring assembly 200, respectively. The suspension arm accommodating grooves 130 are located on the side walls of the housing 100 (i.e., the two first side walls 112 and the two second side walls 122), respectively. Each suspension arm accommodating groove 130 opens at an outer surface of the housing 100. In the embodiment illustrated in FIGS. 1 through 4, the suspension arm accommodating grooves 130 are formed on the first side walls 112 of the first housing 110 and the second side walls 122 of the second housing 120. In other embodiments, the suspension arm accommodating grooves 130 may, alternatively, be formed only on the first side walls 112 or only on the second side walls 122.

Continuing to refer to FIGS. 2 and 3, each suspension arm accommodating groove 130 includes a groove bottom 131, an upper groove wall 132, and a lower groove wall 133. The groove bottom 131 includes, arranged sequentially along a direction from the optical interface 102 to the electrical interface 103, a first plane 131a, a first slope 131b, a second plane 131c, and a third plane 131d. A depth of the second plane 131c in the groove bottom 131 is greater than a depth of the first plane 131a in the groove bottom 131. The first plane 131a and the second plane 131c are of equal width along a direction of a line connecting the first housing 110 and the second housing 120. The third plane 131d is less in width than the second plane 131c along the direction of the line connecting the first housing 110 and the second housing 120. The upper groove wall 132 is formed on the second housing 120, and the lower groove wall 133 is formed on the first housing 110. A notch 132a is formed on the upper groove wall 132, and the notch 132a extends from the second bottom wall 121 to the suspension arm accommodating groove 130 to facilitate disassembly of a handle 214. A travel limiting groove 133b is formed on the lower groove wall 133. The travel limiting groove 133b is a rectangular groove or a U-shaped groove with an opening facing the upper groove wall 132. The notch 132a and the travel limiting groove 133b are both disposed near the second plane 131c.

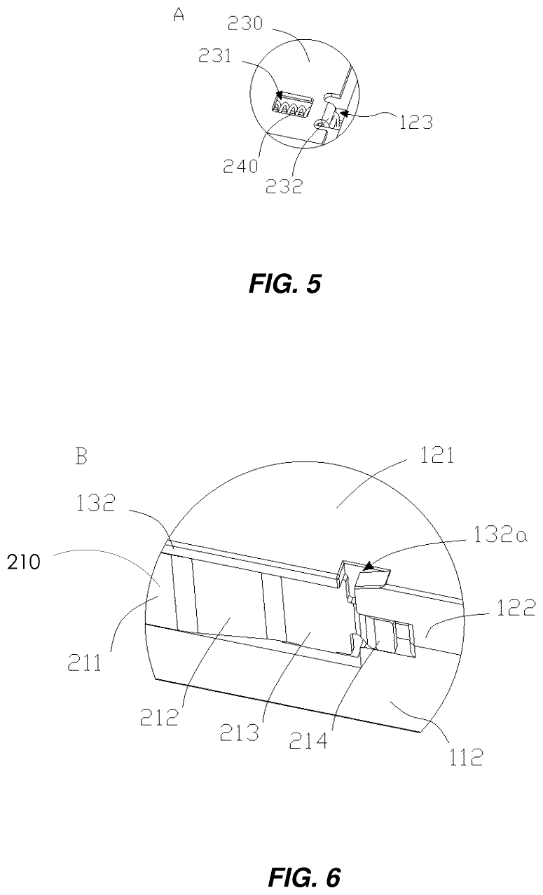

FIG. 5 is an enlarged schematic view of the optical module in FIG. 1 at location A. Referring to FIGS. 1 and 5, in the pull ring assembly 200, the suspension arms 210 and the suspension arm connecting portion 230 are usually metal members, and the pull ring 220 is usually made of a soft material such as rubber. At least one window 231 is disposed on the suspension arm connecting portion 230. The quantity of the windows 231 corresponds to the quantity of the elastic components 240, and the quantity of the windows 231 can be one, two, three, or greater than three. The quantity of the window 231 may be equal to the quantity of the elastic component 240. Alternatively, the quantity of the windows 231 may be greater than the quantity of the elastic components 240, and a plurality of windows 231 are disposed separately. At least one stop block 232 is disposed on an end portion of the suspension arm connecting portion 230 at a location corresponding to the at least one window 231. At the time of assembly, the elastic component 240 enters through the window 231 and reaches below the suspension arm connecting portion 230 and is disposed at the location of the stop block 232. At least one elastic component accommodating groove 123 is disposed on the second housing 120, and the location of the elastic component accommodating groove 123 corresponds to the location of the window 231. At the time of assembly, the elastic component 240 is disposed through the window 231 into the elastic component accommodating groove 123. In the present embodiment, the elastic component 240 is a spring, one end of the spring abuts the stop block 232, and another end of the spring abuts a groove wall at one end of the elastic component accommodating groove 123.

The locations of the window 231, the stop block 232, and the elastic component accommodating groove 123 are not limited to the embodiment described above. According to an alternative embodiment, the window 231 and the stop block 232 may be disposed on at least one of the suspension arms 210, and the window 231 and stop block 232 are disposed correspondingly. Correspondingly, the elastic component accommodating groove 123 is disposed at the groove bottom of the suspension arm accommodating groove 130 at a location corresponding to the window 231 and the stop block 232. The first side wall 112 or the second side wall 122 of the housing 100 is formed with an opening extending from the first bottom wall 111 or second bottom wall 121 of the housing 100 to the suspension arm accommodating groove 130. The opening and the travel limiting groove 133b are obliquely disposed with respect to the suspension arm accommodating groove 130. Here, the term “obliquely disposed” indicates that the opening and the travel limiting groove 133b are diagonally disposed when the suspension arm accommodating groove 130 is a rectangular groove. The stop block 232 on the suspension arm 210 is disposed through the opening into the elastic component accommodating groove 130, so as to enable the suspension arm 130 to be conveniently and rapidly installed into the elastic component accommodating groove 130.

FIG. 6 is an enlarged schematic view of the optical module in FIG. 1 at location B. As shown in FIGS. 1 and 6, each suspension arm 210 is an elongated bar shaped sheet metal member, and includes a first straight-line section 211, a first connecting section 212, a second straight-line section 213, and the handle 214 connected together in the aforementioned sequence. For each suspension arm 210, the handle 214 is located on an end portion of the suspension arm 210. The handle 214 is of a shape similar to “C” and is used for unlocking in cooperation with an external mechanism. The first connecting section 212 is planar and connecting the first straight-line section 211 and the second straight-line section 213, and it is disposed in a slanted manner with respect to the first straight-line section 211 and the second straight-line section 213. The first straight-line section 211, the first connecting section 212, the second straight-line section 213, and the handle 214 are closely fit to the first plane 131a, the first slope 131b, the second plane 131c, and the third plane 131d of the groove bottom 131 of the corresponding suspension arm accommodating groove 130, respectively. Widths of the first straight-line section 211, the first connecting section 212, and the second straight-line section 213 are equal, and a width of the handle 214 is less than the width of the second straight-line section 213. When the pull ring assembly 200 moves, the suspension arms 210 are subject to limitation by the upper groove wall 132 and the lower groove wall 133 and move in the respectively corresponding suspension arm accommodating grooves 130 along a direction of a line connecting the optical interface 102 and the electrical interface 103, and the handles 214 will pop open a locking component on a server socket, thus achieving unlocking of the optical module 10.

Additionally, as shown in FIGS. 2 and 6, in each suspension arm 210, a protrusion 213b is connected to the second straight-line section 213 at a location that corresponds the travel limiting groove 133b of the corresponding suspension arm accommodating groove 130. The protrusion 213b is disposed in the travel limiting groove 133b. The protrusion 213b and the travel limiting groove 133b are disposed near the handle 214, and the protrusion 213b is a sheet structure extending from the suspension arm 210. A sliding distance of the protrusion 213b along the travel limiting groove 133b determines the travel distance of the pull ring assembly 200. The quantity of the protrusion 213b is two, and, similarly, the quantity of the suspension arm 210 is two. The two suspension arms 210 and the two protrusions 213b are disposed in a one-to-one corresponding manner, so that each of two sides of the suspension arm connecting portion 230 has one suspension arm 210 and one protrusion 213b. The protrusion 213b and the suspension arm connecting portion 230 are obliquely disposed with respect to the suspension arm 210, and the term “obliquely disposed” here indicates that the protrusion 213b and the suspension arm connecting portion 230 are diagonally disposed when the suspension arm 210 is a rectangle. It is noted that the suspension arm connecting portion 230 and the protrusion 213b of the suspension arm 210 are obliquely disposed, and the notch 132a on the second housing 120 and the travel limiting groove 133b are located on two sides of the suspension arm accommodating groove 130, so as to avoid interference and to facilitate removal and installation of the pull ring assembly 200.

When the optical module 10 is being assembled, the optical assembly 300 and the circuit board assembly 400 are disposed in the first housing 110 and the second housing 120, and the first housing 110 and the second housing 120 are assembled and fixed together to one another to form a single assembly for a series of debugging and testing. After the debugging and testing are completed, the suspension arms 210 are disposed in the suspension arm accommodating grooves 130, respectively, and the protrusions 213b in the suspension arms 210 are directly fit into the travel limiting grooves 133b in the suspension arm accommodating grooves 130, respectively. At this time, each suspension arm connecting portion 230 is disposed on an external surface of the first bottom wall 111 or the second bottom wall 121 of the housing 100, and the entire assembly process can be completed conveniently and rapidly.

When the pull ring assembly 200 is pulled, the pull ring assembly 200 moves with respect to the housing 100, the suspension arms 210 are subject to limitation by the upper groove wall 132 and the lower groove wall 133 and move left-right along the direction of the line connecting the optical interface 102 and the electrical interface 103. The travel limiting grooves 133b and the protrusions 213b cooperate to limit the left-right moving distance of the pull ring assembly 200 and to limit the suspension arms 210 from moving out of the suspension arm accommodating grooves 130 along a direction perpendicular to the first side wall 112 or the second side wall 122. The upper groove wall 132, the lower groove wall 133, and the travel limiting grooves 133b together limit the suspension arms 210 from separating from the respectively corresponding suspension arm accommodating grooves 130 when the suspension arms 210 move with the pull ring assembly 200, so as to enable the pull ring assembly 200 to move left-right with respect to the housing 100 along the direction of the line connecting the optical interface 102 and the electrical interface 103 steadily and reliably within a set distance.

When the pull ring assembly 200 needs to be replaced, a tool such as a pair of tweezers may be used to pry the suspension arm 210 at locations near the handles 214 through the respectively corresponding notches 132a, so as to pry the suspension arms 210 away from the respectively corresponding suspension arm accommodating grooves 130 by a certain distance. At this time, the protrusions 213b are separated from the respectively corresponding travel limiting grooves 133b, so the suspension arms 210 can be removed from the housing 100, and then a new pull ring assembly 200 may be assembled onto the housing 100. And, in the process of replacement, the assembly formed by the optical assembly 300, the circuit board assembly 400, the first housing 110, and the second housing 120 does not need to be disassembled. Therefore, the replacement of the pull ring assembly 200 does not require re-performance of a series of debugging and testing, and the replacement of the pull ring assembly 200 is simpler and easier and has higher production efficiency.

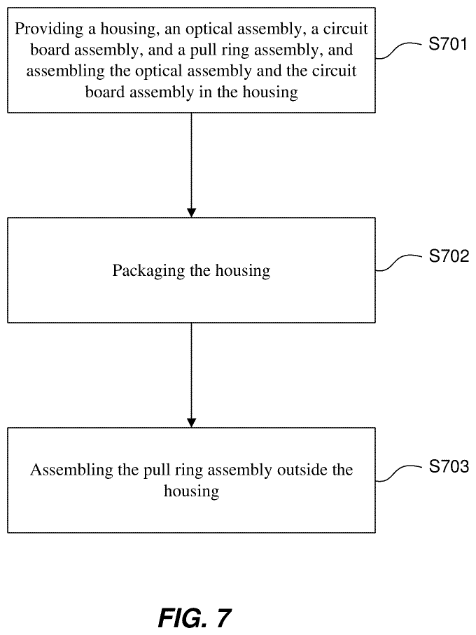

FIG. 7 is a flowchart illustrating an assembly method for an optical module according to an embodiment of the present disclosure. As shown in FIG. 7, the assembly method for the optical module 10 includes the following steps:

Step S701, providing the housing 100, the optical assembly 300, the circuit board assembly 400, and the pull ring assembly 200, and assembling the optical assembly 300 and the circuit board assembly 400 in the housing 100. Specifically, the optical assembly 300 and the circuit board assembly 400 are fixedly disposed in the first housing 110 or the second housing 120.

Step S702, packaging the housing 100. Specifically, the first housing 110 and the second housing 120 may be packaged into one piece by means such as threaded connection, snap-fit connection, protrusion-depression fitting, welded connection, or adhesion.

Step S703, assembling the pull ring assembly 200 outside the housing 100, assembling the suspension arms 210 of the pull ring assembly 200 into the suspension arm accommodating grooves 130, respectively, assembling the elastic component 240 through the window 231 into the elastic component accommodating groove 123, one end of the elastic component 240 abutting the stop block 232, another end of the elastic component 240 abutting a groove wall at one end of the elastic component accommodating groove 123, so as to assemble the pull ring assembly 200. When the pull ring assembly 200 is being assembled into the suspension arm accommodating grooves 130, the pull ring assembly 200 needs to be assembled into the suspension arm accommodating grooves 130 by moving from one side distant from the travel limiting grooves 133b towards the travel limiting grooves 133b. Once the suspension arms 210 are assembled in place completely, the protrusions 214b are also assembled into the travel limiting grooves 133b, respectively.

In the above assembly method for the optical module 10, first, through Step S701, the housing 100, the optical assembly 300, the circuit board assembly 400, and the pull ring assembly 200 are provided, and the optical assembly 300 and the circuit board assembly 400 are disposed in the housing 100. The optical assembly 300, the circuit board assembly 400, and the housing 100 form a single assembly. Next, through Step S702, the housing 100 is packaged, so as to complete the assembly of the optical assembly 300, the circuit board assembly 400, and the housing 100, and subsequent operations are performed after a series of debugging and testing after the assembly. Finally, through Step S703, the pull ring assembly 200 is assembled outside the housing 100. At this time, the suspension arms 210 are disposed in the suspension arm accommodating grooves 130, respectively, and the protrusions 213b are fit in the travel limiting grooves 133b, respectively, thereby completing the assembly of the optical module 10. In the assembly method for the optical module 10, the assembly process is simpler and more convenient.

With the assembly method for the optical module provided by the embodiments of the present disclosure, there is no need to repeat a series of debugging and testing when the pull ring assembly is replaced, and the replacement of the pull ring assembly is simpler and easier and has higher production efficiency.

The various technical features of the above-described embodiments may be combined in any manner, and all possible combinations of the technical features of the above-described embodiments have not been described for the sake of conciseness of description; however, as long as there is no incompatibility in the combinations of these technical features, they should be considered to be within the scope of the present specification as recorded herein.

The above-described embodiments, which are described in a more specific and detailed manner, are only several embodiments of the present disclosure, but they are not to be thus construed as to limit the patent scope of the disclosure. It should be noted that, for persons of ordinary skill in the art, a number of variations and improvements may be made without departing from the conception of the present disclosure, all of which fall within the scope of protection of the present disclosure. Therefore, the scope of protection of the patent for the present disclosure shall be defined by the appended claims.

1. An optical module, comprising:
a housing;
a pull ring assembly disposed on the housing, and an optical assembly and a circuit board assembly disposed in the housing; and
an optical interface and an electrical interface being formed at two opposite ends of the housing,
wherein
the housing comprises a bottom wall and two oppositely disposed side walls formed on the bottom wall; two suspension arm accommodating grooves are formed on the two side walls, respectively; each suspension arm accommodating groove comprises a groove bottom, an upper groove wall, and a lower groove wall; and a travel limiting groove is formed on the lower groove wall of each suspension arm accommodating groove;
the pull ring assembly comprises two oppositely disposed suspension arms and a suspension arm connecting portion connecting the two suspension arms together; a handle used for unlocking in cooperation with an external mechanism, and a protrusion are disposed at an end portion of each suspension arm; and, for each suspension arm, the protrusion is obliquely disposed from the suspension arm connecting portion with respect to the suspension arm;
each suspension arm is disposed in a corresponding one of the suspension arm accommodating grooves; the protrusion of each suspension arm is disposed in the travel limiting groove of the corresponding suspension arm accommodating groove; and the suspension arm connecting portion is disposed on an external surface of the bottom wall of the housing;
when the pull ring assembly moves with respect to the housing, the suspension arms are subject to limitation by the upper groove wall and the lower groove wall and move left-right along a direction of a line connecting the optical interface and the electrical interface, and the travel limiting grooves and the protrusions cooperate to limit a left-right moving distance of the pull ring assembly; and the upper groove wall, the lower groove wall, and the travel limiting grooves together limit the suspension arms from separating from the suspension arm accommodating grooves when the suspension arms move with the pull ring assembly.

2. The optical module according to claim 1, wherein the optical module only comprises two of the suspension arms and two of the protrusions, the two suspension arms and the two protrusions are disposed in a one-to-one corresponding manner.

3. The optical module according to claim 1, wherein the optical module comprises an elastic component; the suspension arm connecting portion is closely fit to an outer surface of the bottom wall of the housing; the suspension arm connecting portion has disposed thereon a window for the elastic component to pass through, and a stop block corresponding to the window; an elastic component accommodating groove used for accommodating the elastic component is disposed on the bottom wall of the housing at a location corresponding to the window and the stop block; and the elastic component is disposed in the elastic component accommodating groove.

4. The optical module according to claim 1, wherein the optical module comprises an elastic component; one of the suspension arms has disposed thereon a window for the elastic component to pass through, and a stop block corresponding to the window; an elastic component accommodating groove used for accommodating the elastic component is disposed on the groove bottom of the corresponding suspension arm accommodating groove at a location corresponding to the window and the stop block; and the elastic component is disposed in the elastic component accommodating groove.

5. The optical module according to claim 4, wherein an opening running through from the bottom wall of the housing to the elastic component accommodating groove is disposed on the corresponding side wall of the housing; the opening is obliquely disposed from the corresponding travel limiting groove with respect to the corresponding suspension arm accommodating groove; and the stop block on the suspension arm is disposed through the opening into the elastic component accommodating groove.

6. The optical module according to claim 1, wherein a notch running through from the bottom wall of the housing to one of the suspension arm accommodating grooves is disposed on the corresponding side wall; the notch is disposed at a location near the handle; and the notch and the travel limiting groove are disposed on two opposite sides of the suspension arm accommodating groove.

7. The optical module according to claim 1, wherein the housing of the optical module comprises a first housing and a second housing fixed to one another; and each suspension arm accommodating groove is disposed at a junction location of the first housing and the second housing and is on both the first housing and the second housing at the same time.

8. The optical module according to claim 1, wherein the protrusion and the travel limiting groove are disposed near the handle.

9. An optical module, comprising:
a first housing, a second housing, a pull ring assembly, an optical assembly, and a circuit board assembly; wherein the first housing and the second housing are assembled and fixed to one another; the pull ring assembly is disposed outside the first housing and the second housing; the optical assembly and the circuit board assembly are disposed in the first housing and the second housing; and
an optical interface and an electrical interface are formed at two opposite ends of the first housing and the second housing;
wherein
the first housing and the second housing each comprises a bottom wall and two oppositely disposed side walls formed on the bottom wall; two suspension arm accommodating grooves are formed on the two side walls of the first housing, the second housing, or the first housing and the second housing; each suspension arm accommodating groove comprises a groove bottom, an upper groove wall, and a lower groove wall; and a travel limiting groove is formed on the lower groove wall of each suspension arm accommodating groove;
the pull ring assembly comprises two oppositely disposed suspension arms; a handle used for unlocking in cooperation with an external mechanism, and a protrusion are disposed at an end portion of each suspension arm;
each suspension arm is disposed in a corresponding one of the suspension arm accommodating grooves; the protrusion of each suspension arm is disposed in the travel limiting groove of the corresponding suspension arm accommodating groove; and a suspension arm connecting portion is disposed on an external surface of the bottom wall of one of the first housing and the second housing; and
after the first housing and the second housing are fixed together, the suspension arms are assembled into the respectively corresponding suspension arm accommodating grooves.

10. An assembly method for the optical module of claim 1, comprising:
providing the housing, the optical assembly, the circuit board assembly, and the pull ring assembly, and assembling the optical assembly and the circuit board assembly in the housing;
packaging the housing; and
assembling the pull ring assembly outside the housing.

11. The assembly method for the optical module of claim 3, further comprising:
providing the housing, the optical assembly, the circuit board assembly, and the pull ring assembly, and assembling the optical assembly and the circuit board assembly in the housing;
packaging the housing; and
assembling the pull ring assembly outside the housing,
wherein the assembling the pull ring assembly outside the housing comprises:
assembling the pull ring assembly into the suspension arm accommodating grooves; and
assembling an elastic component into an elastic component accommodating groove through a window.

12. The assembly method for the optical module according to claim 11, wherein the assembling the pull ring assembly into the suspension arm accommodating grooves comprises:
assembling the pull ring assembly into the suspension arm accommodating grooves by moving the pull ring assembly from one side distant from a travel limiting groove towards the travel limiting groove.
